(19) United States
(12) Patent Application Publication
(10) Pub. No.: US 2024/0234982 A9
(43) Pub. Date: Jul. 11, 2024

(54) High-Voltage Thermal Fuse

(71) Applicant: Intercable Automotive Solutions GmbH, Bruneck (IT)

(72) Inventors: Markus Alexander Fiebig, Hamburg (DE); Christoph Baumgartner, Bruneck (IT)

(21) Appl. No.: 18/401,550

(22) Filed: Dec. 31, 2023

Related U.S. Application Data
(63) Continuation of application No. PCT/EP22/68327, filed on Jul. 1, 2022.

(30) Foreign Application Priority Data
Jul. 2, 2021 (EP) 21183547

(51) Int. Cl. H01M 50/581; H01H 85/02; H01H 85/041; H01M 50/502

(52) U.S. Cl. CPC H01M 50/581; H01H 85/0241; H01H 85/041; H01M 50/502; H01M 2200/103; H01M 2220/20

(57) ABSTRACT

A device for electrical and mechanical connection of a first element and a second element includes first and second connection elements and a connection module. The first connection element includes a first interface configured to be electrically and mechanically connected to the first element. The second connection element includes a second interface configured to be connected electrically and mechanically to the second element. The connection module is configured to provide an electrical and mechanical connection between a first connection region of the first connection element and a second connection region of the second connection element. The connection module is configured to passively open the electrical and mechanical connection between the first connection region of the first connection element and the second connection region of the second connection element in response to a triggering temperature being reached.

### CROSS-REFERENCE TO RELATED APPLICATIONS

This application is a continuation of International Application No. PCT/EP2022/068327 filed Jul. 1, 2022, which claims the benefit of EP Application No. 21183547 filed Jul. 2, 2021. The entire disclosures of the above applications are incorporated by reference.

### FIELD

The present invention relates to electromechanical connections and more particularly to electromechanical connections with passive fuses.

### BACKGROUND

Module connectors and busbars are generally known from the state of the art. Module connectors are used, for example, to connect battery modules to each other. The interconnected battery modules form a battery or an energy storage device. The battery modules, also known as cell modules, each comprise twelve 60 Ah cells, for example. The battery modules are arranged in a housing tray of an electric vehicle, for example. The battery modules serve as energy storage for the electric vehicle. The busbars in turn connect the interconnected battery modules to the battery management system, the charging interface or the interface to the drive unit.

High safety requirements are placed on energy storage devices in electric vehicles. In the event of unintended reactions within the energy storage device, special safety measures are required to reduce the risk to occupants.

In this context, it has now become apparent that there is a need to further improve such a module connector, in particular there is a further need to provide a cost-effective and safe module connector. It is therefore a task of the present invention to provide an improved module connector, in particular it is a task of the present invention to provide a module connector that is as cost-effective and safe as possible.

These and other tasks, which are still mentioned when reading the following description or can be recognized by the skilled person, are solved by the subject matter of the independent claims. The dependent claims further shape the central idea of the present invention in a particularly advantageous manner.

### SUMMARY

A device according to the invention for electrically and mechanically connecting battery modules in an energy storage device or two busbars between an energy storage device and a further system, comprising a first connection element with a first interface, wherein the first interface is configured to be electrically and mechanically connected to a first battery module in an energy storage device or a first busbar connected to an energy storage device; a second connection element with a second interface, wherein the second interface is configured to be electrically and mechanically connected to a second battery module in the energy storage device or a second busbar connected to a further system; a connection module, wherein the connection module is configured to provide an electrical and mechanical connection between a first connection region of the first connection element and a second connection region of the second connection element; wherein the connection module is further configured to passively open the electrical and mechanical connection between the first connection region of the first connection element and the second connection region of the second connection element when a triggering temperature is reached.

The electrical connection, in the present case, means a conductive connection of a pole (for example a positive pole) of a first battery module with a pole (for example a corresponding negative pole) of a second battery module for the transmission of current. The electrical connection can be used to connect or interconnect several battery modules and thus increase the capacity of an energy storage device comprising the respective battery modules. Furthermore, the electrical connection in this case means the conductive connection of a first busbar (or power rail), which is connected to an energy storage device of an electric vehicle, to a second busbar (or power rail), which is connected to a further system. The further system is, for example, a battery management system, a charging interface, an interface to the drive unit in the electric vehicle or another energy storage device. The mechanical connection, in the present case, means that the electrical connection is realized via one or more mechanical elements, for example busbars. The mechanical connection is also used to transfer heat via heat conduction between battery modules and/or the energy storage device and other/further systems. Opening the mechanical connection interrupts the heat transfer via heat conduction. Opening the mechanical connection interrupts the electrical connection. The term busbar refers to a conductor for electrical current made of a rigid material, such as copper. The busbar can be in one or more parts. It should be noted that the first busbar and second busbar can also be a first part and a second part of a single busbar. In addition to electricity, the busbar can also transmit heat. In the present case, the term battery module refers to an energy storage device that is designed to be connected to a further energy storage device. Preferably, the term battery module refers to an energy storage device that comprises several pouch cells. The term connection element is to be understood broadly here and includes all mechanical elements that are set up to connect two elements to each other. The connection element can have different geometries. For example, the connection element can have a rod-shaped geometry, an arc-shaped geometry, a triangular geometry or a trapezoidal geometry. The connection element can, for example, have a cylindrical, square, rectangular, polygonal or oval cross-section. The connection element can have a constant or variable cross-section (or material thickness) over the length of the connection element. The connection element serves as a means of transferring electricity and heat, with the heat being dissipated from the battery modules. The connection element can be made of any conductive material. For example, the connection element is made of copper, aluminum with a tin coating or aluminum with a nickel coating. The term interface is to be understood broadly here and means a mechanical interface, for example a through-hole rung, a slotted hole, each of which can be connected to a pole of a battery module with a corresponding screw. For example, the mechanical interface can also be designed as a contact surface for a clamping device that connects the connection element to the terminal with a force fit. The term connection region is to be understood broadly in the present case and includes a mechanical area of the connection element. For example, the connection region is arranged opposite the interface. For example, the connection region is designed as a flat area that is accessible through and is set up to form a force-fit/friction-locked connection (e.g. clamping) with a corresponding counterpart. For example, the connection region has the same cross-section as the remaining region of the connection element excluding the interface. For example, the connection region has a rectangular cross-section and a rectangular and flat connecting surface. In other words, the connection region can be a partial region of the busbar, which region is used for clamping. The term connection module is to be understood broadly here and means a mechanical component that is designed to establish an electrical and mechanical connection between two connection regions and to passively open and/or release the electrical and mechanical connection when a triggering temperature is reached. The connection regions are preferably arranged spatially separated from each other. In the present case, the term passive opening means that no external energy has to be added for opening and there is no active activation. Furthermore, passive means that the opening is automatic and independent. The term trigger temperature means a predetermined temperature, for example 140° C. or 170° C., at which a fault in the battery module can be inferred. When the trigger temperature is reached, the connection module opens the connection between the first connection region of the first connection element and the second connection region of the second connection element. For example, the connection module is designed as a mechanical device with a temperature-dependent safety mechanism. The mechanical device comprises, for example, a spring mechanism, a cable pull system, a clamping mechanism or a gear mechanism for providing the electrical and mechanical connection and for opening it. The passive opening takes place, for example, via temperature-sensitive materials, whereby the materials can be solid or liquid. The temperature-sensitive materials can have positive or negative coefficients of thermal expansion.

The invention is based on the insight that in the event of short circuits, intended thermal reactions and/or unwanted chemical reactions within a battery module, there is a great risk that the event will spread to the neighboring battery modules. The high temperatures and/or excessively high currents are passed on to neighboring connected battery modules via the connection elements. This can lead to a thermal chain reaction, which can ultimately result in a fire and/or an explosion of the energy storage device. Due to the high risk to life and limb of the occupants of a vehicle, it is necessary to delay this thermal chain reaction or the fire and/or explosion for as long as possible when an initial event occurs (i.e. failure of a first battery module) so that the occupants can get to safety. Such an initial event can be triggered, for example, by a traffic accident or by an unintended chemical reaction inside the battery cells. It is a problem that as a result of the traffic accident, not only the parts of the battery module can be damaged, but also the controls, actuators, energy and control lines, such that an active opening of the electrical and mechanical connection may no longer be possible. The present invention solves the problem by providing a connection module that is set up to passively provide an electrical and mechanical connection below a trigger temperature between a first connection region of a first connection element of a first battery module and a second connection region of a second connection element of a second battery module. This ensures operation of the battery under normal conditions. When the trigger temperature is reached, a passive safety mechanism is triggered, which opens the electrical and mechanical connection between the first connection region of the first connection element of the first battery module and the second connection region of the second connection element of the second battery module in such a way that thermal propagation (i.e. thermal runaway) of the entire energy storage device of the vehicle is delayed. This can advantageously give the occupants of the vehicle time to move away from the vehicle. In other words, the invention is a thermal fuse for high-voltage systems.

Preferably, the connection module comprises a passive safety element that is set up to trigger at the temperature limit such that the electrical and mechanical connection between the first connection region of the first connection element and the second connection region of the second connection element is opened. The term passive safety element is to be understood broadly at and means a safety element that is set up to trigger a safety mechanism without external energy supply or control. The passive safety element comprises, for example, a temperature-sensitive material. The temperature-sensitive material changes its volume when the temperature changes, for example. For example, the temperature-sensitive material has a positive coefficient of thermal expansion and is a liquid that is arranged in a glass container, such as an ampoule. When the triggering temperature is reached, the glass container bursts, which passively triggers the safety mechanism. For example, the temperature-sensitive material has a negative coefficient of thermal expansion and is a solid. When the triggering temperature is reached, for example, a clamp is released, which passively triggers the locking mechanism. Advantageously, this makes it possible to reliably ensure the opening of the connection between the first connection element and the second connection element independently of higher-level control systems and/or energy systems.

Preferably, the passive safety element comprises a container with a liquid which is designed to burst when the triggering temperature is reached. Preferably the container is a bursting vessel with liquid according to EP 2630994, EP 3360605, U.S. Pat. Nos. 9,579,531, 9,821,181, 9,889,324 and/or KR 20130097674. The liquid may be, for example, halon, fluorinated ketone or a perfluorinated ethyl isopropyl ketone. The liquid can be selected so that at a certain limit temperature it expands in such a way that the bursting vessel bursts or breaks. The liquid can advantageously undergo a phase transition and become gaseous, which significantly increases the volume and thus the speed of expansion. This can advantageously ensure that the liquid is distributed around the first and second connection regions.

Preferably, the connection module comprises a third connection element that is set up to be electrically and mechanically connected to the first connection region of the first connection element and to the second connection region of the second connection element. The third connection element is made of copper, for example. The third connection element has, for example, a round, oval, square, rectangular or polygonal cross-section. Preferably, the third connection element has a rectangular cross-section. Preferably, the third connection element has a similar cross-section to the first and second connection elements. Preferably, the third connection element is friction-locked to the first connection element and the second connection element. The third connection element can advantageously be used to provide high currents between the first battery module and the two battery modules. The third connection element is pressed against the first connection element and the connection element via the safety element, for example, in such a way that an electrical and mechanical connection is provided. In other words, the high current is not conducted via the safety element, but via the third connection element.

Preferably, the connection module comprises a spring mechanism that is configured to provide the electrical and mechanical connection between the first connection region of the first connection element and the second connection region of the second connection element. The spring mechanism ensures simplified assembly and secure assembly of the three connection elements and the locking element. Advantageously, the safety element can be reliably brought into force-fit engagement with the third connection element via the spring mechanism without damaging it by, for example, an interference fit. Furthermore, the spring mechanism can advantageously compensate manufacturing and/or assembly tolerances. Furthermore, the spring mechanism can advantageously be passively released or opened again when pre-tensioned via the locking element.

Preferably, the spring mechanism is pretensioned via the container in such a way that the third connection element is pressed against the first connection region of the first connection element and the second connection region of the second connection element. This reliably enables an electrical and mechanical connection between the first battery module and the second battery module, which is opened again when the triggering temperature is reached by bursting the safety element or the holder.

Preferably, the connection module comprises a housing with at least one opening, wherein the housing closes the at least one opening when the triggering temperature is reached in such a way that at least the first connection region of the first connection element and the second connection region of the second connection element and a released liquid are enclosed with regard to the environment so that the liquid cannot escape from the housing and can cover the first connection region of the first connection element and the second connection region of the second connection element to extinguish an electric arc. Hot gases or a hot air flow can reach the vicinity of the connection module through the at least one opening in the housing. The hot gases or the hot air flow are caused by the temperature rise of the battery modules as a result of a malfunction. The opening can have a positive effect on the reaction time of the connection module, as the housing does not have to be completely heated until the trigger temperature is reached. This means that the electrical and mechanical connection can be opened passively more quickly. When the connection between two battery modules connected to each other is opened, a direct-current conductor causes an electric arc, which prevents the electrical connection from opening and can therefore initiate or intensify the thermal runaway. The released liquid can then advantageously counteract the resulting electric arc and thus separate or open the electrical and thermal connection in order to prevent or delay the thermal runaway. The housing can, for example, be designed in such a way that it passively closes the opening again when the triggering temperature is reached. This can be realized, for example, via a slider construction, which is also triggered via the passive safety element. The housing can be designed in one or more parts. In the case of a multi-part design, the housing can, for example, be mounted using plug-in connections, screw connections, adhesive connections and/or welded connections.

Preferably, the liquid is an extinguishing liquid. Advantageously, this can better counteract the electric arc.

Preferably, the container is arranged essentially at the level of the first connection region of the first connection element and the second connection region of the second connection element or above it. An arrangement at the level of or above the first connection element and the second connection element advantageously allows the liquid to reach the electric arc directly in order to extinguish it efficiently. The container is therefore not arranged below the third connection element in the obvious way, but above it in the opposite way. This is made possible, for example, via a slider construction, whereby the container is not brought into direct engagement with the third connection element, but indirectly via a slider that is firmly connected to the third connection element.

Preferably, the housing is made of a high-temperature-resistant plastic. This can advantageously ensure the safe and correct functioning of the device for the electrical and mechanical connection of battery modules even in the event of an extreme rise in temperature.

A further aspect relates to a system comprising: at least one device described in more detail above; at least one first battery module and a second battery module; and/or at least one energy storage device and a further system; at least a first and a second busbar between the energy storage device and the further system.

Preferably, the further system is a battery management system, a charging interface, an interface of a drive unit or an additional energy storage device.

A further aspect relates to a vehicle comprising a system described in more detail above.

A further aspect relates to the use of a container with extinguishing liquid contained therein in a device described in more detail above.

A further aspect relates to the use of a connection module with a passive fuse for interrupting the electrical and mechanical connection in a device described in more detail above.

### BRIEF DESCRIPTION OF THE DRAWINGS

A detailed description of the figures is given below.

FIG. 1 shows a schematic view of a device for the electrical and mechanical connection of battery modules in the energy storage device or two busbars between an energy storage device and a further system of an example embodiment;

FIG. 2 shows a schematic sectional view of a device for the electrical and mechanical connection of battery modules in the energy storage device or two busbars between an energy storage device and a further system of an example embodiment in the closed state;

FIG. 3 shows a schematic sectional view of a device for the electrical and mechanical connection of battery modules in the energy storage device or two busbars between an energy storage device and a further system of an example embodiment in the open state;

FIG. 4 shows a schematic view of a device for the electrical and mechanical connection of battery modules in the energy storage device or two busbars between an energy storage device and a further system of an example embodiment;

FIG. 5 shows a schematic view of a system of an example embodiment;

FIG. 6 shows a schematic view of a vehicle of an example embodiment; and

FIG. 7 shows a schematic view of a system of an example embodiment.

### DETAILED DESCRIPTION

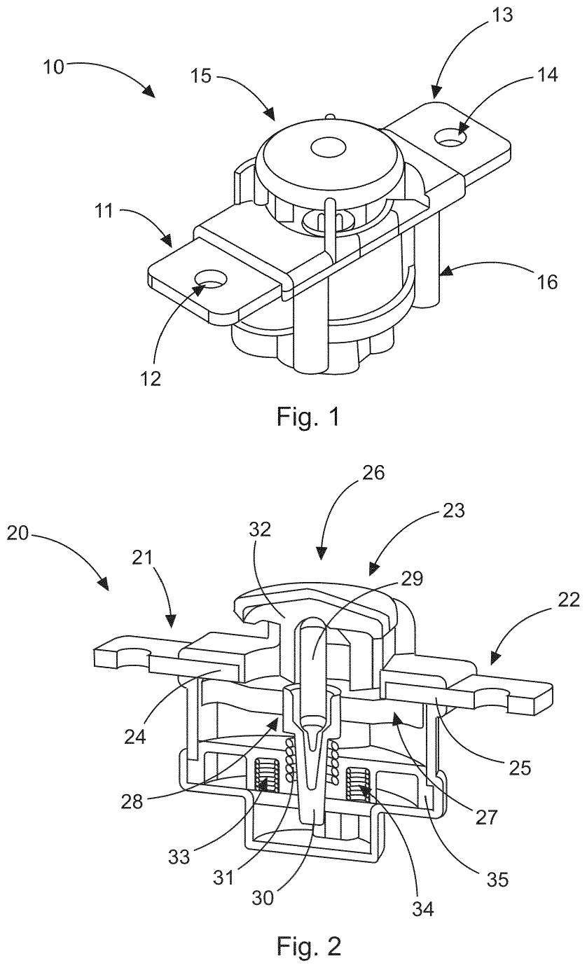

FIG. 1 shows a schematic view of a device 10 for electrically and mechanically connecting battery modules (not shown) or two busbars between an energy storage device and a further system (not shown). The device 10 comprises a first connection element 11 with a first interface point 12, wherein the first interface 12 is set up to be electrically and mechanically connected to a first battery module or a first busbar of the energy storage device. In the present case, the first connection element 11 is a flat part made of copper. The first interface 12 is designed as a through-hole. The first connection element 11 can be connected to a pole of a first battery module (not shown) via the hole using a corresponding screw (not shown). The device 10 further comprises a second connection element 13 with a second interface 14, wherein the second interface 14 is configured to be electrically and mechanically connected to a second battery module or a second busbar of an adjacent system. The second connection element 13 and the second interface 14 are designed identically to the first connection element 11 and the first interface 12. Furthermore, the device 10 comprises a connection module 15. The connection module 15 has a housing 16 made of high-temperature-resistant plastic.

FIG. 2 shows a schematic sectional view of a device 20 for the electrical and mechanical connection of battery modules or two busbars between an energy storage device and a further system in the closed state. The connection elements 21 and 22 are arranged in the housing 23 of the connection module 26 in such a way that a first connection region 24 of the first connection element 21 and a second connection region 25 of the second connection element 22 protrude into the housing 23. The connection module 26 comprises a third connection element 27, which is configured to be electrically and mechanically connected to the first connection region 24 of the first connection element 21 and to the second connection region 25 of the second connection element 22. The third connection element 27 is made of copper in the present case and has a through-hole 28, which is arranged in the middle. The electrical and mechanical connection is provided force-fit between the first connection region 24 and the third connection element 27 and between the second connection region 25 and the third connection element 27. The connection module 26 further comprises a passive safety element 29. The passive safety element 29 is in the present case a container with a liquid which is set up to burst when a temperature limit value is reached. In the present case, the liquid is an extinguishing liquid and is not electrically conductive. In the present case, the extinguishing liquid is perfluorinated ethyl isopropyl ketone. The connection module 26 is configured to passively open the connection between the first connection region 24 of the first connection element 21 and the second connection region 25 of the second connection element 22 at a temperature limit value. The connection module 26 further comprises a receptacle 30 made of plastic, which is set up to receive the passive safety element 29 on one side. The receptacle 30 is mounted in a base element 35 via a spring 31 and guided through the through-hole 28 of the third connection element 27. The connection module 26 also comprises a slider 32, to which the third connection element 27 is fixed (in this case via a fitting connection). The slider 32 is movably mounted or guided in the housing 23. The base element 35 is fixedly arranged in the housing 23. The slider 32 is supported on an underside of the base element 35 via the springs 33 and 34. To provide the electrical and mechanical connection between the first connection element 21 and the third connection element 27 and between the second connection element 22 and the third connection element 27, the safety element 29 is inserted between an upper side of the slider 32 and in the receptacle 30 in such a way that the slider 32 together with the third connection element 27 is pressed in a force-fit manner against the first connection region 24 of the first connection element 21 and against the second connection region 25 of the second connection element 22. The springs 31, 33 and 34 form a spring mechanism which is set up to provide an electrical and mechanical connection between the first connection region 24 of the first connection element 21 and the second connection region 25 of the second connection element 22 via the third connection element 27. As described above, the spring mechanism is pretensioned via the passive safety element 29 in such a way that the third connection element 29 is pressed against the first connection region 24 of the first connection element 21 and against the second connection region 25 of the second connection element 22. The safety element 29 is arranged essentially at the level of or above the first connection region 24 of the first connection element 21 and the second connection region 25 of the second connection element 22. This arrangement is made possible by the slider 32 and the resulting indirect movement of the third connection element 35. Without the slider 32, an alternative arrangement of the safety element 29 below the third connection element 35 would be conceivable. However, this would have the disadvantage that any liquid released would be less able to be distributed between the first connection region 24 and the third connection element 35 and between the second connection region 25 and the third connection element 35 and would therefore not be able to counteract a resulting electric arc as efficiently when the connection is opened.

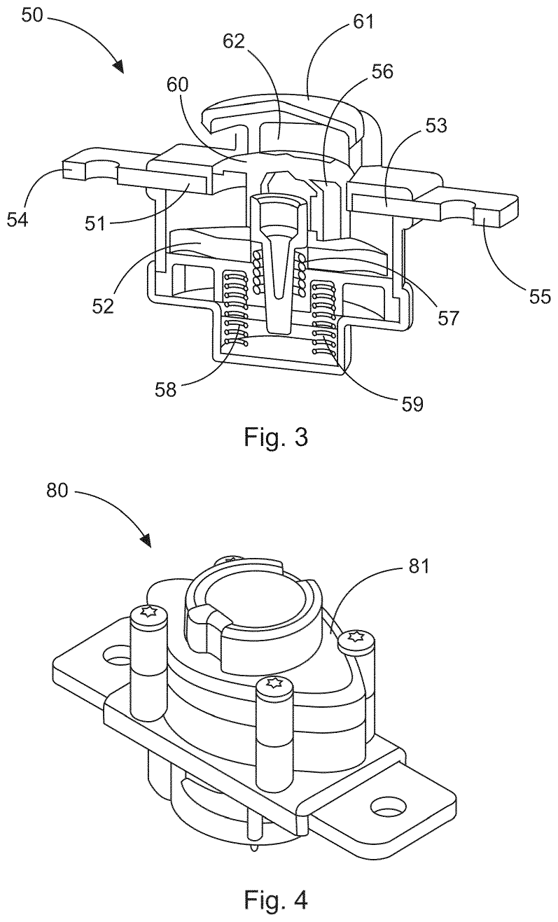

FIG. 3 shows a schematic sectional view of a device 50 for the electrical mechanical connection of battery modules or two busbars between an energy storage device and a further system in an open state. In this case, the open state means that the passive safety element 29 has triggered due to reaching a temperature limit value and the connection between the first connection region 51 of the first connection element 54 and the third connection element 52 and between the second connection region 53 of the second connection element 55 is therefore open. The bursting of the safety element 29 (not shown) causes the slider 56 together with the third connection element 52 to move vertically downwards. The springs 57, 58 and 59 of the spring mechanism relax and thus initiate the vertical movement. The housing 61 has the opening 62 in the present case. The upper side 60 of the slider 56 closes the housing 61, in particular the opening 62, so that the housing 61 encloses the first connection region 51 of the first connection element 54, the third connection element 52, the second connection region 53 of the second connection element 55 and the liquid released by the bursting of the safety element 29 with respect to the environment, so that the released liquid cannot escape from the housing 61 and can cover the first connection region 51 of the first connection element 54, the second connection region 53 of the second connection element 55 and the third connection element 52 to extinguish an electric arc. The electric arc is created by the opening of the DC connection between the first connection element 54 and the third connection element 52 as well as the third connection element 52 and the second connection element 55.

FIG. 4 shows a schematic view of a device 70 for the electrical mechanical connection of battery modules or two busbars between an energy storage device and a further system. In contrast to the devices shown in FIGS. 1 to 3, the device 70 comprises a housing 71 that has no openings.

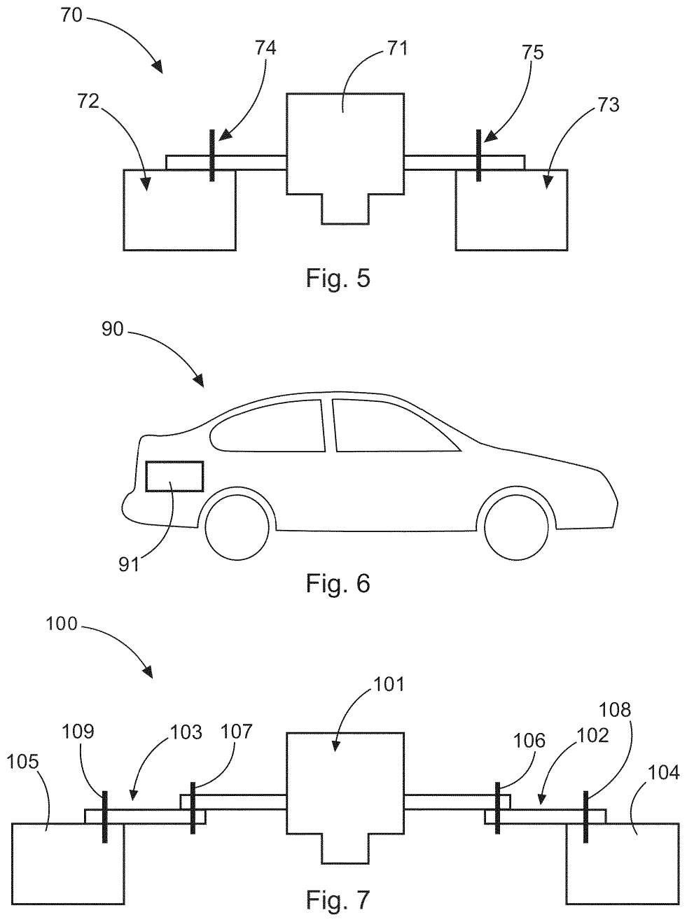

FIG. 5 shows a schematic view of a system 70, comprising a device 71 described in more detail above for the electrical and mechanical connection of battery modules or two busbars between an energy storage device and a further system. The system 70 further comprises a first battery module 72 and a second battery module 73. One pole of the first battery module 72 is connected to the device 71 via a screw 74. A pole of the second battery module 73 is connected to the device 71 via a screw 75. The screw connection enables a power line between the first battery module 72 indirectly via the device 71 and the second battery module 73.

FIG. 6 shows a vehicle 90 together with a system 91 described in more detail above.

FIG. 7 shows a schematic view of a system 100, comprising a device 101 described in more detail above for the electrical and mechanical connection of battery modules or two busbars between an energy storage device and a further system. The system 100 further comprises a first busbar 102, which is connected to an energy storage device 104 via a screw 108. The system 100 also comprises a second busbar 103, which is connected to a further system 105, in this case a battery management system, via a screw 109. Alternatively, the further system 105 could also be a charging interface, an interface of a drive unit or a further energy storage device. The device 101 mechanically and electrically connects the busbars 102 and 103 to each other via the screws 106 and 107 and thus indirectly connects the energy storage device 104 and the additional system 105.

The term non-transitory computer-readable medium does not encompass transitory electrical or electromagnetic signals propagating through a medium (such as on a carrier wave). Non-limiting examples of a non-transitory computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The term “set” generally means a grouping of one or more elements. The elements of a set do not necessarily need to have any characteristics in common or otherwise belong together. The phrase “at least one of A, B, and C” should be construed to mean a logical (A OR B OR C), using a non-exclusive logical OR, and should not be construed to mean “at least one of A, at least one of B, and at least one of C.” The phrase “at least one of A, B, or C” should be construed to mean a logical (A OR B OR C), using a non-exclusive logical OR.

1. A device for electrical and mechanical connection of a first element and a second element, the device comprising:
a first connection element with a first interface, wherein the first interface is configured to be electrically and mechanically connected to the first element;
a second connection element with a second interface, wherein the second interface is configured to be connected electrically and mechanically to the second element; and
a connection module configured to:
provide an electrical and mechanical connection between a first connection region of the first connection element and a second connection region of the second connection element, and
passively open the electrical and mechanical connection between the first connection region of the first connection element and the second connection region of the second connection element in response to a triggering temperature being reached.

2. The device of claim 1 wherein:
the connection module includes a passive safety element configured to trigger in response to the triggering temperature being reached, and
triggering of the passive safety element opens the electrical and mechanical connection between the first connection region of the first connection element and the second connection region of the two connection elements.

3. The device of claim 2 wherein:
the passive safety element includes a container with a liquid; and
the liquid is configured to burst when the triggering temperature is reached.

4. The device of claim 3 wherein the connection module includes a spring mechanism configured to provide the electrical and mechanical connection between the first connection region of the first connection element and the second connection region of the second connection element.

5. The device of claim 4 wherein the connection module includes a third connection element that is configured to be electrically and mechanically connected to the first connection element and to the second connection element.

6. The device of claim 5 wherein the spring mechanism is pretensioned via the container in such a way that the third connection element is pressed against the first connection region of the first connection element and the second connection region of the second connection element.

7. The device of claim 3 wherein:
the connection module includes a housing with at least one opening; and
the housing closes the at least one opening in response to the triggering temperature being reached such that at least the first connection region of the first connection element and the second connection region of the second connection element and the liquid are enclosed with respect to the environment so that the liquid does not escape from the housing and can cover the first connection region of the first connection element and the second connection region of the second connection element to extinguish an electric arc.

8. The device of claim 3 wherein the liquid is an extinguishing liquid.

9. The device of claim 3 wherein the container is arranged substantially at a level of or above the connection region of the first connection element and the second connection region of the second connection element.

10. The device of claim 7 wherein the housing includes a high-temperature-resistant plastic.

11. The device of claim 1 wherein:
the first element is a first busbar between an energy storage device and a further system; and
the second element is a second busbar between the energy storage device and the further system.

12. A system comprising:
the device of claim 11;
the energy storage device;
the first busbar; and
the second busbar.

13. The system of claim 12 further comprising:
the further system,
wherein the further system includes at least one of a battery management system, a charging interface, or an interface of a drive unit.

14. A vehicle comprising the system of claim 12.

15. The device of claim 1 wherein:
the first element is a first battery module in an energy storage device; and
the second element is a second battery module in the energy storage device.

16. A system comprising:
the device of claim 15; and
the energy storage device, including the first battery module and the second battery module.

17. A vehicle comprising the system of claim 16.

18. A method of operating a connection between a first element and a second element, the connection including a first connection element with a first interface that is configured to be electrically and mechanically connected to the first element, the connection including a second connection element with a second interface that is configured to be connected electrically and mechanically to the second element, the method comprising:
providing an electrical and mechanical connection between a first connection region of the first connection element and a second connection region of the second connection element; and
passively opening the electrical and mechanical connection between the first connection region of the first connection element and the second connection region of the second connection element in response to a triggering temperature being reached.

19. The method of claim 18 wherein the passively opening is performed using a container holding extinguishing liquid.

20. The method of claim 18 wherein the passively opening is performed using a passive fuse.
